(19) United States
(12) Patent Application Publication
(10) Pub. No.: US 2006/0139364 A1
(43) Pub. Date: Jun. 29, 2006

(54) Image processing device, portable information processing device and controlling method thereof

(75) Inventors: Sang-chul Shin, Yongin-si (KR); Jae-il Joo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/189,719

(22) Filed: Jul. 27, 2005

(30) Foreign Application Priority Data
Dec. 29, 2004 (KR) 2004-114707

(51) Int. Cl. G09G 5/00

(52) U.S. Cl. 345/581

(57) ABSTRACT

An image processing device, a portable information processing device and a controlling method thereof are provided. The image processing device includes a first storage storing user attribute information applied to the image processing device; and a first controller, provided that different user attribute information is downloaded to the portable information processing device, updating the user attribute information of the image processing device with the different user attribute information of the portable information processing device. Therefore, the user can apply the same attribute information to other image processing devices.

### CROSS-REFERENCE TO RELATED APPLICATIONS

This application claims priority from Korean Patent Application No. 2004-114707, filed on Dec. 29, 2004, the entire content of which is incorporated herein by reference.

### BACKGROUND OF THE INVENTION

1. Field of the Invention

Apparatuses and methods consistent with the present invention relate in general to an image processing device, a portable information processing device and a controlling method thereof, and more specifically, to an image processing device where a user is able to set various types of attribute information, a portable information processing device for use with the image processing device and a controlling method thereof.

2. Description of the Related Art

In general, an image processing device receives video and/or audio signals from a variety of image sources, and provides the signals to a user through an external output device or a built-in output device.

To meet the diverse needs of users and technical advances, the image processing device provides various types of attribute information to users according to their personal preferences. In other words, a user could obtain desired images and/or sounds by simply controlling the image processing device according to a personal preference even though a considerable amount of time and effort was put into selecting desired attribute information and setting up user attribute information. Once the user attribute information is set up based on the attribute information being selected, it is stored in a nonvolatile memory of the image processing device. Thus, although the image processing device is turned off, the user attribute information is not deleted. When the image processing device is subsequently turned, the user attribute information is applied to the image processing device.

However, the above-described image processing device has a drawback. For instance, suppose that a user sets attribute information for an image processing device, and then uses a different image processing device, hoping to utilize the same user attribute information which was previously set. According to related art technologies, the user cannot utilize the same attribute information which was previously set. Instead, the user has to go through the same procedure again in order to set the attribute information for the new image processing apparatus. To most users this is not an easy task because it depends mainly on their ability to remember the attribute information they previously set. Not only can this give much pressure to the users to remember every single attribute information they previously set, but also takes extra time and effort.

### SUMMARY OF THE INVENTION

The present invention provides an image processing device, a portable information processing device and a controlling method thereof, which enables a user to transfer user attribute information between image processing devices through a portable information processing device. As such, even though the user may use a different image processing device, the user can easily set the same user attribute information for a new image processing device through the portable information processing device.

According to an aspect of the present invention, there is provided an image processing device interfaceable with a portable information processing device, which includes: a first storage storing user attribute information applied to the image processing device; and a first controller, provided that different user attribute information is downloaded to the portable information processing device, updating the user attribute information of the image processing device with the different user attribute information of the portable information processing device.

In an exemplary embodiment, if version of the user attribute information of the image processing device is different from version of the user attribute information of the portable information processing device, the first controller downloads the user attribute information from the portable information processing device to the image processing device.

The image processing device may further include a display unit for displaying a determination of the first controller to a user when the first controller determines as to whether the user attribute information stored in the image processing device and the user attribute information stored in the portable information processing device are the same version.

The image processing device may further include a first input unit for enabling a user to input an upload command for uploading the user attribute information stored in the portable information processing device to the image processing device.

The user attribute information may include at least one of channel information, screen attribute information, and sound attribute information.

The image processing device may further include a power supply unit for supplying power for charging a battery for use in the portable information processing device.

Another aspect of the present invention provides a portable information processing device interfaceable with an image processing device, which includes: a second storage; and a second controller for controlling the second storage to store user attribute information applied to the image processing device.

In an exemplary embodiment, if an upload request signal is transmitted from a third party image processing device, the second controller transmits the user attribute information stored in the second storage to the third party image processing device.

The portable information processing device may further include a battery that is charged with power supplied from the image processing device.

Still another aspect of the present invention provides a controlling method of an image processing device and a portable information processing device, wherein the method includes: downloading user attribute information set in the image processing device onto the portable information processing device; uploading the downloaded user attribute information onto a third party image processing device; and applying the uploaded user attribute information to the third party image processing device.

The controlling method may further include: identifying whether version of the user attribute information stored in the image processing device is same as the version of pre-set user attribute information in the third party image processing device, and in the uploading step, in the uploading step, if the version of the user attribute information stored in the image processing device is different from the version of pre-set user attribute information in the third party image processing device, uploading the attribute information stored in the image processing device.

### BRIEF DESCRIPTION OF THE DRAWINGS

The above and other aspects of the present invention will be more apparent by describing exemplary embodiments of the present invention with reference to the accompanying drawings, in which:

FIG. 1 is a schematic block diagram of an image processing system according to an exemplary embodiment of the present invention;

FIG. 2 is a schematic block diagram of an image processing device according to an exemplary embodiment of the present invention;

FIG. 3 is a schematic block diagram of a portable information processing device according to an exemplary embodiment of the present invention;

FIG. 4 is a flow chart for explaining a method of downloading user attribute information according to an exemplary embodiment of the present invention, which is seen from the perspective of an image processing device;

FIG. 5 is a flow chart for explaining a method of downloading user attribute information according to an exemplary embodiment of the present invention, that is seen from the perspective of a portable information processing device;

FIG. 6 is a flow chart for explaining a method of uploading user attribute information according to an exemplary embodiment of the present invention, that is seen from the perspective of an image processing device; and

FIG. 7 is a flow chart for explaining a method of uploading user attribute information according to an exemplary embodiment of the present invention, that is seen from the perspective of a portable information processing device.

### DETAILED DESCRIPTION OF THE EXEMPLARY EMBODIMENTS

Exemplary embodiments of the present invention will be described herein below with reference to the accompanying drawings. Well-known functions or constructions are not described in detail in order to prevent obscuring the invention in unnecessary detail.

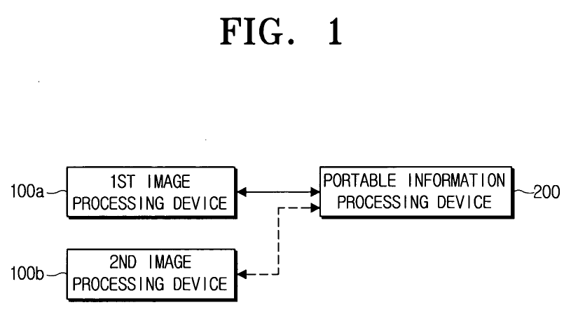

FIG. 1 is a schematic block diagram of an image processing system according to an exemplary embodiment of the present invention.

Referring to FIG. 1, the image processing system includes a portable information processing device 200, and at least one image processing device. A first image processing device 100a and a second image processing device 100b are included in the image processing system. Examples of the image processing device include digital TVs and set-top boxes. Examples of the portable information processing device include a cell phone, a portable personal computer (PC), and a Personal Digital Assistant (PDA). The portable information processing device 200 can be installed in the first and second image processing devices 100a and 100b. To this end, the portable information processing device 200 and each of the image processing devices 100a and 100b should have an interface (not shown) so that the portable information processing device 200 can be installed and interfaced with the first and second image processing devices 100a and 100b.

According to the present invention, various types of user attribute information which is set by a user is stored in the first image processing device 100a.

Here, the user attribute information is attribute information set by a user. Examples of the user attribute information include channel information, screen attribute information and sound attribute information. These attributes are carefully adjusted in accordance with the preference of the user. In effect, any type of attribute information can be of the user attribute information as long as the attribute information is set up by the user.

As such, the user attribute information stored in the first image processing device 100a is applied to the first image processing device 100a.

Upon the request of the user, the user attribute information stored in the first image processing device 100a is downloaded to the portable information processing device 200 and stored therein. Then, the user separates the portable information processing device 200 from the first image processing device 100a, and installs the portable information processing device 200 in the second image processing device 100b. At user request, the user attribute information stored in the portable information processing device 200 is uploaded to the second image processing device 100b and stored therein. That is, user attribute information previously stored in the second image processing device 100b is updated with the user attribute information provided from the portable information processing device 200. The updated user attribute information is then applied to the second image processing device 100b. In this manner, the user attribute information that was pre-stored and applied to the first image processing device 100a is now applied to the second image processing device 100b.

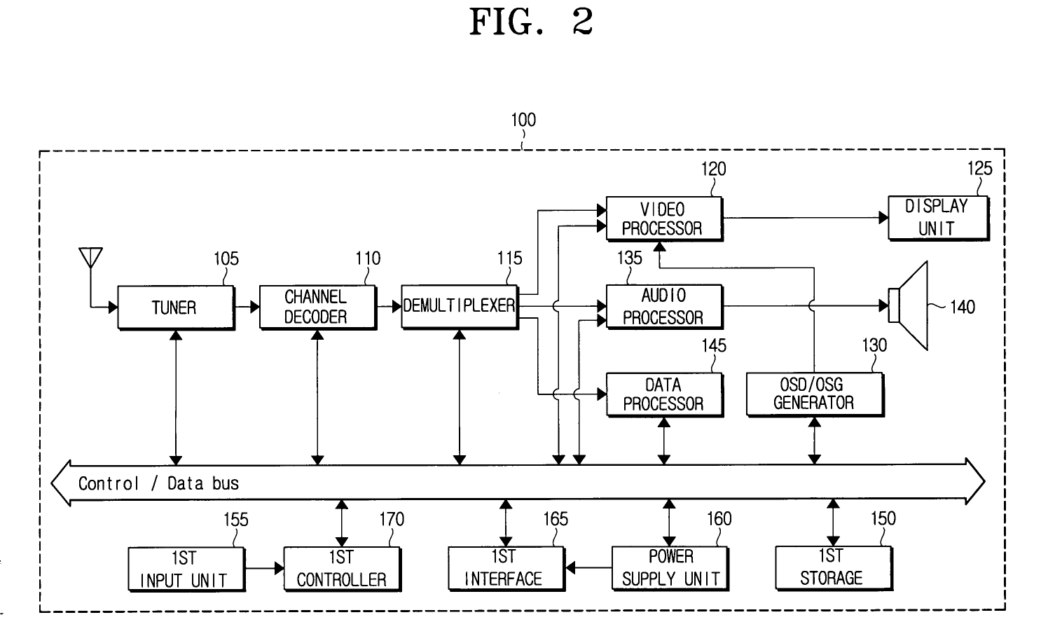

FIG. 2 is a schematic block diagram of an image processing device according to an exemplary embodiment of the present invention.

Referring to FIG. 2, the image processing device 100 includes a tuner 105, a channel decoder 110, a demultiplexer 115, a video processor 120, a display unit 125, an On Screen Display/On Screen Graphic (OSD/OSG) generator 130, an audio processor 135, a speaker 140, a data processor 145, a first storage 150, a first input unit 155, a power supply unit 160, a first interface 165, and a first controller 170.

The tuner 105 receives a broadcasting signal from a channel it selects. In general, a broadcasting signal contains broadcast data and supplementary data.

The channel decoder 110 demodulates and decodes a received broadcasting signal, as opposed to the modulation and coding schemes of the transmitter side.

The demultiplexer 115 separates a channel-decoded broadcasting signal into video data, audio data, and supplementary data. Here, the supplementary data is data necessary for providing various services. For instance, Electronic Program Guide (EPG), the program guide information, is included in the supplementary data.

The video processor 120 decodes video data using a given algorithm, and performs signal processing on the decoded video to make it displayable on the display device 125. The display device 125 is a device for externally displaying video signals. Examples of the display device 125 include a liquid crystal display (LCD), and a plasma display panel (PDP). Here, the video processor 120 performs signal processing on the video data, according to the screen attribute information set by the user.

The OSD/OSG generator 130 generates OSD and OSG screens portrayed with text, images, symbols etc. to convey a notification message. That is, images on the OSD/OSG screen are combined with a video signal and output to the display unit 125.

The audio processor 135 decodes audio data using a given algorithm, and performs signal processing on the decoded audio data to make it outputable by the speaker 140. Here, the audio processor 135 performs signal processing on the audio data, according to the sound attribute information set by the user.

The data processor 145 collects and reconstructs supplementary data transmitted by diverse protocols. More specifically, the supplementary data is separated by the demultiplexer 115, and reconstructed conforming to a relevant protocol to be meaningful data, or the first data being transferred.

The first storage 150 stores a first control program for controlling the image processing device 100. Also, the first storage 150 stores EPG information that is processed by the data processor 145, and a user menu screen that enables the user to set channels, screens, and sounds according to the user's personal preference.

The first storage 150 stores user attribute information in a designated memory area. Examples of the first storage 150 include a non-volatile RAM (NVRAM) and a flash memory.

The first input unit 155 is equipped with at least one operating button to enable the user to input various commands. An input command signal input through the first input unit 155 is provided to the first controller 170, and the first controller 170 controls the image processing device 100 in response to the input command signal. Examples of the first input unit 155 include front panel and remote control.

According to an exemplary embodiment of the present invention, user commands such as user menu screen display, download and upload, are all input through the first input unit 155.

The power supply unit 160 a provides charging current or a charging voltage to external devices, under the control of the first controller 170.

The first interface 165 makes it possible to communicate all kinds of data and information between the image processing device 100 and external devices. The first interface 165 is connected to the second interface 240 of the portable information processing device 200. Examples of the first interface 165 includes a Universal Serial Bus (USB) port, a serial port, a parallel port, and a PS2 port.

The first controller 170 controls the overall operation of the image processing device 100 with the first control program stored in the first storage 150.

For instance, if a user menu screen display command is input through the first input unit 155, the first controller 170 reads out the user menu screen from the first storage 150, and controls the OSD/OSG generator 130 to generate an OSD screen or an OSG screen from the user menu screen. If the user already set attribute information through the user menu screen, the first controller 170 controls the first storage 150 to store user attribute information corresponding to the attribute information that has been set.

In addition, if the first interface 165 of the image processing device 100 is connected to the second interface 240 of the portable information processing device 200, the first controller 170 identifies whether the version of the user attribute information stored in the first storage 150 of the image processing device 100 is same as the version of the user attribute information stored in the portable information processing device 200. If they are the same, the first controller 170 controls the display unit 125 to display a message notifying that the versions are the same. On the other hand, if they are not the same, the first controller 170 controls the display unit 125 to display a message notifying that the versions are different. As for the version of user attribute information the date the user set the attribute information can be used. But this is for illustrative purposes only and the present invention is not to be limited thereto.

In another example, the user inputs a download command through the first input unit 155. Then, the first controller 170 reads out the user attribute information from the first storage 150, and transmits it to the portable information processing device 200.

Further, if the user inputs an upload command through the first input unit 155, the first controller 170 generates an upload request signal and transmits the signal to the portable information processing device 200. Optionally, it is also possible that if the upload command is not input through the first input unit 155 and if the version of the user attribute information stored in the first storage 150 of the image processing device 100 is different from the version of the user attribute information stored in the portable information processing device 200, the first controller 170 automatically transmits the upload request signal to the portable information processing device 200.

Under the control of the first controller 170, the user attribute information transmitted to the portable information processing device 200 in response to the upload request signal is updated in the first storage 150.

In case that the image processing device 100 and the portable information processing device 200 are connected, the first controller 170 controls the power supply unit 160 to provide the charging current or the charging voltage to the portable information processing device 200.

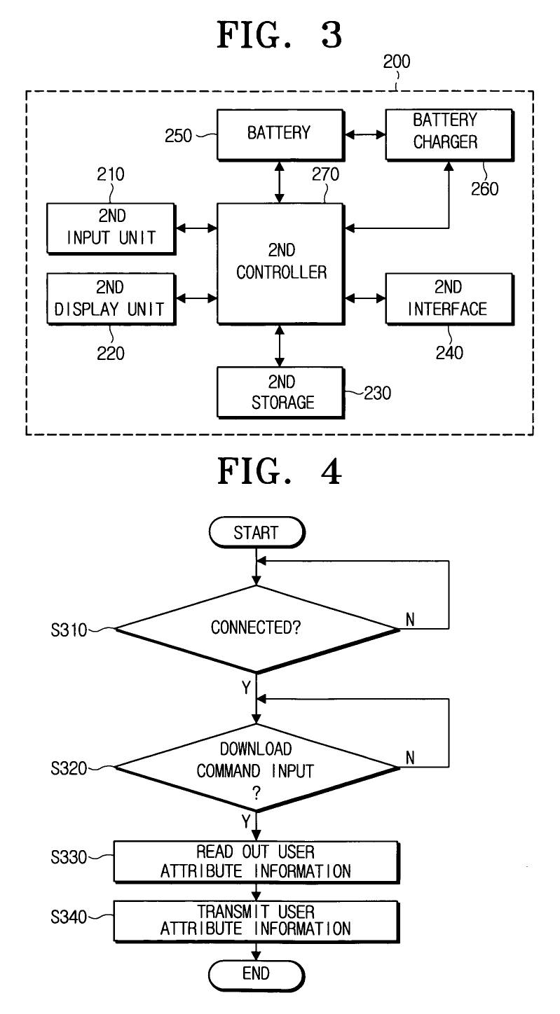

FIG. 3 is a schematic block diagram of a portable information processing device according to a preferred embodiment of the present invention.

Referring to FIG. 3, the portable information processing device 200 includes a second input unit 210, a second display unit 220, a second storage 230, a second interface 240, a battery 250, a battery charger 260, and a second controller 270.

The second input unit 210 is equipped with at least one operating button to enable the user to input various commands. An input command signal input through the second input unit 210 is provided to the second controller 270, and the second controller 270 controls the portable information processing device 200 in response to the input command signal. Examples of the second input unit 210 include a key panel and a touch panel.

The second display unit 220 displays various notification messages and all kinds of information, in response to a user command or under the control of the second controller 270.

The second storage 230 stores the second control program for controlling the overall operation of the portable information processing device 200.

In particular, the second storage 230 stores user attribute information that is transmitted from the image processing device 100. Examples of the second storage unit 230 includes a NVRAM and a flash memory.

The second interface makes it possible to communicate all kinds of data and information between the portable information processing device 200 and external devices. The second interface 240 is connected to the first interface 165 of the image processing device 100. To this end, the second interface 240 provides an interface corresponding to the first interface 165.

The battery 250 provides power to the portable information processing device 200. The battery 250 may be removably attached to the portable information processing device 200. The battery 250 is charged by a separate battery charging device.

Optionally, if the portable information processing device 200 and the image processing device 100 are connected to each other, the charging current or the charging voltage flows into the battery 250 through the image processing device 100.

The battery charger 260 charges the battery 240 using the charging current or the charging voltage that flows through the second interface unit 240.

The second controller 270 controls the overall operation of the portable information processing device 200 with the second control program stored in the second storage 230.

The second controller 270 also controls the second storage 230 to store user attribute information that is received through the second interface 240.

In addition, if an upload request signal is received through the second interface 240, the second controller 270 reads the user attribute information from the second storage 230, and transmits it to the image processing device 100 through the second interface 240.

Also, if the charging current or the charging voltage is supplied from the image processing device 100, the second controller 270 controls the battery charger 260 to charge the battery 250.

FIG. 4 is a flow chart for explaining a method of downloading user attribute information according to an exemplary embodiment of the present invention, which is seen from the perspective of an image processing device. The image processing device used in this method is an image processing device for applying user attribute information pre-stored therein to a different image processing device. The first image processing device 100a in FIG. 1 corresponds to the image processing device used in the method described in FIG. 4.

Referring to FIG. 4, the portable information processing device 200 is installed in the first image processing device 100a, and the two devices 100a and 200 are interfaced through the first and second interfaces 165 and 240, respectively (S310). If a download command is input through the first input unit 155 (S320), user attribute information is read out from the first storage 150 under the control of the first controller 170 (S330).

Then, under the control of the first controller 170, the user attribute information is transmitted to the portable information processing device 200 through the first interface 165 (S340).

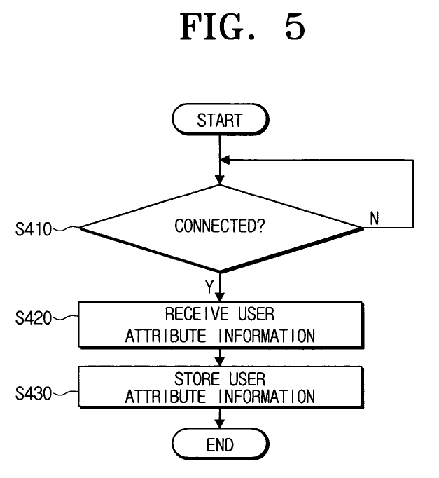

FIG. 5 is a flow chart for explaining a method of downloading user attribute information according to an exemplary embodiment of the present invention, that is seen from the perspective of a portable information processing device. The image processing device used in this method is an image processing device for applying user attribute information pre-stored therein to a different image processing device. The first image processing device 100a in FIG. 1 corresponds to the image processing device used in the method described in FIG. 5.

Referring to FIG. 5, the portable information processing device 200 is installed in the first image processing device 100a, and the two devices 100a and 200 are interfaced through the first and second interfaces 165 and 240, respectively (S410). User attribute information transmitted from the first image processing device 100a is received through the second interface 240 (S420).

Then, the received user attribute information is stored in the second storage 230 under the control of the controller 270 (S430).

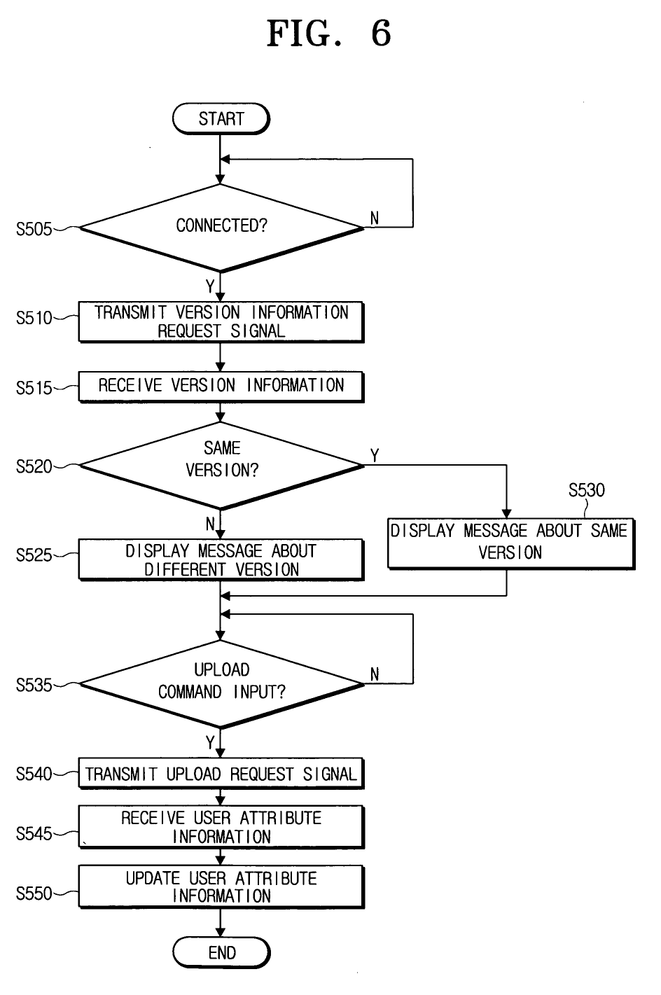

FIG. 6 is a flow chart for explaining a method of uploading user attribute information according to an exemplary embodiment of the present invention, that is seen from the perspective of an image processing device. The image processing device used in this method is an image processing device for updating user attribute information stored in the portable information processing device with user attribute information set in a different image processing device. The second image processing device 100b in FIG. 1 corresponds to the image processing device used in the method described in FIG. 6.

Referring to FIG. 6, the portable information processing device 200 is installed in the second image processing device 100b, and the two devices 100b and 200 are interfaced through the first and second interfaces 165 and 240, respectively (S505). A version information request signal generated by the first controller 170 is transmitted to the portable information processing device 200 through the first and second interfaces 165 and 240 (S510).

In response to the version information request signal, version information on the user attribute information stored in the second storage 230 of the portable information processing device 200 is transmitted to the second image processing device 100b (S515).

Then, the first controller 170 identifies whether the version of the user attribute information from the portable information processing device 200 is same as the version of the user attribute information stored in the second image processing device 100b (S520).

If the versions are different, a message indicating that the versions are different is displayed on the display unit 125, under the control of the first controller 170 (S525).

On the other hand, if the versions are the same a message indicating that the versions are the same is displayed on the display unit 125, under the control of the first controller 170 (S530).

Based on the messages displayed in operations S525 and S530, an upload command is input through the first input unit 155 (S535). In this case, an upload request signal is generated under the control of the first controller 170, and the signal is then transmitted to the portable information processing device 200 (S540).

In response to the upload request signal transmitted to the portable information processing device 200, the portable image processing device 200 sends the user attribute information stored therein to the second image processing device 100b (S545).

The received user attribute information is stored and updated in the first storage 150 under the control of the first controller 170 (S550).

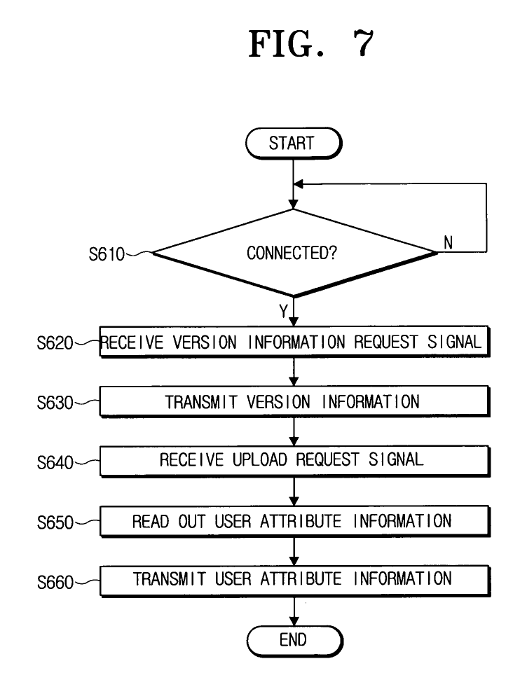

FIG. 7 is a flow chart for explaining a method of uploading user attribute information according to an exemplary embodiment of the present invention, that is seen from the perspective of a portable information processing device. The image processing device used in this method is an image processing device for updating user attribute information stored in the portable information processing device with user attribute information set in a different image processing device. The second image processing device 100b in FIG. 1 corresponds to the image processing device used in the method described in FIG. 7.

Referring to FIG. 7, the portable information processing device 200 is installed in the second image processing device 100b, and the two devices 100b and 200 are interfaced through the first and second interfaces 165 and 240, respectively (S610). If a version information request signal generated by the first controller 170 is transmitted to the portable information processing device 200 (S620), version information on the user attribute information stored in the second storage 230 is transmitted to the second image processing device 100b, under the control of the second controller 270 (S630).

On the other hand, if an upload request signal is received from the second image processing device 100b (S640) the second controller 270 reads out user attribute information from the second storage 230 (S650).

Then, the user attribute information is transmitted to the second image processing device 100b through the second and the first interface 240, 165, under the control of the second controller 270 (S660).

As described above, the image processing device, the portable information processing device and the controlling method thereof enable a user to transfer user attribute information from one image processing device to another with the help of the portable information processing device. As such, even though the user may use a different image processing device in a different place, the user can easily set up the same user attribute information to a new image processing device through the portable information processing device. Provided that the image processing device and the portable information processing device are connected to each other, it is also possible to charge the battery of the portable information processing device through the image processing device, thereby increasing user convenience.

The foregoing exemplary embodiments are merely exemplary and are not to be construed as limiting the present invention. The present invention can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image processing device interfaceable with a portable information processing device, the image processing device comprising:
a first storage which stores user attribute information applied to the image processing device; and
a first controller which updates the user attribute information stored in the first storage with different user attribute information stored in the portable information processing device.

2. The image processing device according to claim 1, wherein, if the user attribute information stored in the first storage is different from the user attribute information stored in the portable information processing device, the first controller downloads the user attribute information from the portable information processing device to the image processing device.

3. The image processing device according to claim 1, further comprising:
a display unit which displays a determination of the first controller to a user when the first controller determines whether the user attribute information stored in the first storage and the user attribute information stored in the portable information processing device are the same.

4. The image processing device according to claim 1, further comprising a first input unit which enables a user to input an upload command for uploading the user attribute information stored in the portable information processing device to the image processing device.

5. The image processing device according to claim 1, wherein the user attribute information includes at least one of channel information, screen attribute information, and sound attribute information.

6. The image processing device according to claim 1, further comprising a power supply unit which supplies power for charging a battery of the portable information processing device.

7. A portable information processing device interfaceable with an image processing device, the portable information processing device comprising:
a storage; and
a controller which controls the storage to store user attribute information applied to and received from the image processing device.

8. The portable information processing device according to claim 7, wherein, if an upload request signal is transmitted from another image processing device, the controller transmits the user attribute information stored in the storage to the other image processing device.

9. The portable information processing device according to claim 7, further comprising a battery that is charged with power supplied from the image processing device.

10. A method of controlling an image processing device and a portable information processing device, the method comprising:
downloading user attribute information stored in a first image processing device to the portable information processing device;
uploading the user attribute information from the portable information processing device to a second image processing device; and
applying the user attribute information, which is uploaded, to the second image processing device.

11. The method according to claim 9, further comprising:
identifying whether the user attribute information downloaded to the portable information processing device is same as pre-set user attribute information stored in the second image processing device, and
the uploading comprises, if the user attribute information downloaded to the portable information processing device is different from the pre-set user attribute information stored in the second image processing device, uploading the attribute information from the portable information processing device to the second image processing device.

12. The method according to claim 9, wherein the user attribute information includes at least one of channel information, screen attribute information, and sound attribute information.
